(19) United States
(12) Patent Application Publication
(10) Pub. No.: US 2020/0047261 A1
(43) Pub. Date: Feb. 13, 2020

(54) KEY DUPLICATING MACHINE

(71) Applicant: KEYLINE S.P.A., Conegliano (IT)

(72) Inventors: Enrico TOME', Sacile (IT); Giorgio POL, Conegliano (IT); David REBULL, Trebaseleghe (IT); Massimo BIANCHI, Cappella Maggiore (IT)

(73) Assignee: KEYLINE S.P.A., Conegliano (IT)

(21) Appl. No.: 16/605,673

(22) PCT Filed: Apr. 23, 2018
(86) PCT No.: PCT/IB2018/052803

§ 371 Date: Oct. 16, 2019

(30) Foreign Application Priority Data
Apr. 21, 2017 (IT) 102017000044302

(51) Int. Cl. B23C 3/35; B23Q 35/28

(52) U.S. Cl. CPC B23C 3/35; B23C 2235/48; B23C 2235/32; B23Q 35/28

(57) ABSTRACT

A key duplicating machine includes a clamp configured to retain a key to be copied, a reader assembly for reading cuts of the key, and a cutting tool for reproducing the cuts on a blank key. The reader includes a support bearing a feeler element with an end which contacts the cuts on the key and is movable with respect to the support along a first reference direction (Y) parallel to a resting plane. A position sensor, in electronic communication with a controller, continuously detects position changes along the first reference direction (Y) of the feeler element with respect to the support. The support or the clamp is movable along at least a second reference direction (X) that is orthogonal to the first reference direction. During movement of the support or clamp along the second reference direction, the reading end maintains contact with the cuts to follow the cut shapes.

### FIELD OF THE INVENTION

The present invention falls within the field of machines and/or equipment for duplicating keys. In particular, the present invention relates to a key duplicating machine comprising an assembly for reading the cuts of a flat key.

### BACKGROUND ART

Flat keys, usually employed for locks and cylinders, typically comprise a head portion and a barrel portion. The latter has grooves which substantially define a profile compatible with the lock/cylinder associated with the key. Along at least one of the sides thereof, the barrel portion comprises instead a series of notches/engravings passing through the entire thickness of the key. The shape of such notches/engravings defines the “cuts” or “code” of the key.

As known, the duplication of a key is carried out by means of duplicating machines which reproduce the cuts on a blank key. More precisely, mechanical key duplicating machines and electronic key duplicating machines are known.

In a mechanical key duplicating machine, a pair of clamps is provided for, to secure respectively an original key to be duplicated and a blank key to be shaped according to the original key to obtain a copy key. A mechanical duplicating machine further comprises a fixed mechanical feeler, to detect the cuts of the key to be duplicated, and a cutting tool, to replicate the cuts on the blank key. The two clamps are typically installed on a common base, movable along two orthogonal directions, which is moved directly by an operator, typically by means of a lever. The duplication on the blank key occurs upon a movement of the base which exactly replicates the cuts of the key to be duplicated. More precisely, the operator acts on the base so as to maintain the key to be duplicated in contact with the feeler element and so that the contact point moves along the cuts in their entirety. During this “tracing” action, the movement of the base is transferred to the blank key which is thus machined by the cutting tool in a manner corresponding to the cuts. The latter maintains a fixed position with respect to the base.

In electronic key duplicating machines, a software is further provided for, which manages the duplication operations upon the reading of the cuts typically carried out by means of an optical reading system. An example of an electronic machine is described in patent application WO 2015/010936. Such an electronic machine comprises a structure bearing a first support, movable along two orthogonal directions, on which a clamp is mounted, adapted to block, at separate times, the key to be duplicated and the blank key. The machine further comprises an optical reader to detect the cuts of the key to be duplicated and a cutting tool for reproducing the cuts on the blank key. The optical reader and the cutting tool are mounted on a second support which is fastened to the structure of the machine. The machine described in WO 2015/010936 further comprises an electronic control unit which controls the movement of the first support, the rotation of the cutting tool and the operation of the optical reader. The key to be duplicated is initially blocked in the clamp installed on the first support. The latter is subsequently moved so that the optical reader can detect the cuts of the key. The signals generated by the optical sensor are transmitted to the control unit to be stored and processed by means of a software which stores the cuts. At the end of the reading, the key to be duplicated is replaced with the blank one. Following an activation command, the control unit actuates the cutter and moves the first support so that the cutter carries out the previously stored cuts on the blank key.

In general, with respect to mechanical duplicating machines, the electronic machine described in WO 2015/010936 provides for a same clamp for reading the key to be duplicated and for the subsequent machining of the blank key. This solution makes the machine more compact or, in the same space, it allows the installation of a further operating assembly for duplicating keys of a different type, for example, of the laser type.

The electronic machine described in WO 2015/010936, although showing advantages with respect to a mechanical one, has some limitations related to the employment of the optical sensor. First of all, it has been proven that such a sensor is a critical aspect in terms of final realization costs. Furthermore, the reading of the cuts is strongly affected by the possible presence of dirt, surface residues or grease thereat. In fact, the presence of surface residues, such as, for example, shavings, filings or metal powder, locally alters the profile of the cuts. In the subsequent duplication step, the control unit moves the blank key with respect to the cutting tool on the basis of “altered” cuts, detected by the optical sensor, which do not correspond to the real ones of the original key. This obviously leads to a duplicated key functionally not compatible with the original one. Therefore, in this type of machines, a continuous and meticulous control of the cuts surface conditions is necessary, so as to ensure an accurate reading and limit waste. This aspect negatively affects the operating times and, in general, the productivity of the duplicating machine.

Therefore, the need arises to provide a technical solution allowing to overcome the limits set out above which distinguish the machine described in WO 2015/010936 and more generally the key duplicating machines which employ an optical system for reading the cuts of the original key.

In view of such a need, the main aim of the present invention is to provide an electronic machine for duplicating keys capable of overcoming the drawbacks described above. Within this aim, it is a first object of the present invention to provide a key duplicating machine which allows an accurate and reliable reading of the cuts of the key to be copied. Another aim, linked to the previous one, is to provide a key duplicating machine in which the reading of the cuts of the key is not affected by the possible presence of dirt, grease and/or debris at the cuts themselves. It is another object of the present invention to provide a key duplicating machine which allows a high productivity and therefore reduced dead times. It is another, not least important, object of the present invention to provide an assembly for reading the cuts of a key which is reliable and easy to manufacture at competitive costs.

### SUMMARY

The technical aim specified is substantially achieved by a key duplicating machine comprising a clamp configured to block at least one original key to be copied, a reading assembly for reading the cuts of said original key and a cutting tool for reproducing said cuts on a blank key. The duplicating machine in accordance with the invention is characterized in that the reading assembly comprises a support bearing a feeler element which is movable, with respect to the support, along a first reference direction; such a feeler element comprises a reading end contacting the original key at the cuts.

The reading assembly further comprises:
elastic means interposed between the support and the feeler element; such elastic means push the feeler element away from the support;
a position sensor configured to detect the position, or the change of position, of the feeler element with respect to the support; the position sensor is electrically connected to a control unit of the machine.

According to the invention, one of said support and said clamp is movable along at least a second reference direction, orthogonal to the first reference direction.

The machine according to the invention allows a greater accuracy in copying the key, precisely by virtue of the structure of the reading assembly based on the employment of a mechanical feeler element directly contacting the cuts of the key due to the thrust exerted by elastic means. The latter ensure a stable contact of the reading end of the feeler element against the cuts of the key. In particular, for the relative motion (along the second reference direction) which extends between the clamp and the support, the reading end runs along the cuts determining a corresponding movement of the feeler element along the first reference direction. Such a movement is detected by the position sensor. Advantageously, the electrical signal provided by the sensor to the control unit is in no way affected by the surface conditions of the cuts. Furthermore, the running of the reading end along the cuts results in a scraping action which eliminates any possible dirt or debris present at the cuts themselves.

### BRIEF DESCRIPTION OF THE DRAWINGS

Further features and the advantages of the present invention will become more apparent from the following detailed description of possible embodiments of an assembly for reading the cuts of a key in accordance with the invention with reference to the accompanying drawings, in which:

FIG. 1 shows a perspective view of a key duplicating machine according to the present invention;

FIGS. 2 and 3 respectively show a side view and a front view of the machine of FIG. 1;

FIGS. 4 and 5 show plan views of the machine of FIG. 1 in two different operating configurations;

FIGS. 6 and 7 respectively show a front view and a plan view of an assembly of components of a key duplicating machine in accordance with the invention in a reading configuration;

FIGS. 8 and 9 respectively show a front view and a plan view of the reading assembly of FIGS. 6 and 7 in a possible resting configuration;

FIGS. 10 and 11 show a further front view and a further plan view of the assembly of FIGS. 6 and 7 in said reading configuration and in an operating condition different from that shown in FIGS. 6 and 7 themselves;

FIGS. 12 and 13 show perspective views from different points of view of the reading assembly shown in FIGS. 6 and 7;

FIGS. 14 and 15 show perspective views from different points of view of the reading assembly shown in FIGS. 8 and 9;

FIGS. 16 and 17 show perspective views from different points of view of the reading assembly shown in FIGS. 10 and 11;

In the aforementioned Figures, the same reference numbers and the same reference letters identify the same elements or components.

### DETAILED DESCRIPTION

With reference to the accompanying Figures, an electronic machine for duplicating keys in accordance with the invention is generally indicated by reference numeral 3. Such a machine 3 is preferably employed for duplicating flat keys. For the objects of the present invention, “flat key” means a generic key of the type shown in FIGS. 5 and 7, i.e., comprising two faces 5A, 5B, a head portion 5C and a barrel portion 5D which predominantly extends along a main direction. One side of the barrel portion 5D comprises a series of notches/engravings 6 passing between the two faces 5A, 5B; the shape of such notches/engravings defines the cuts of the key. Therefore, the cuts will be indicated in the following by reference numeral 6.

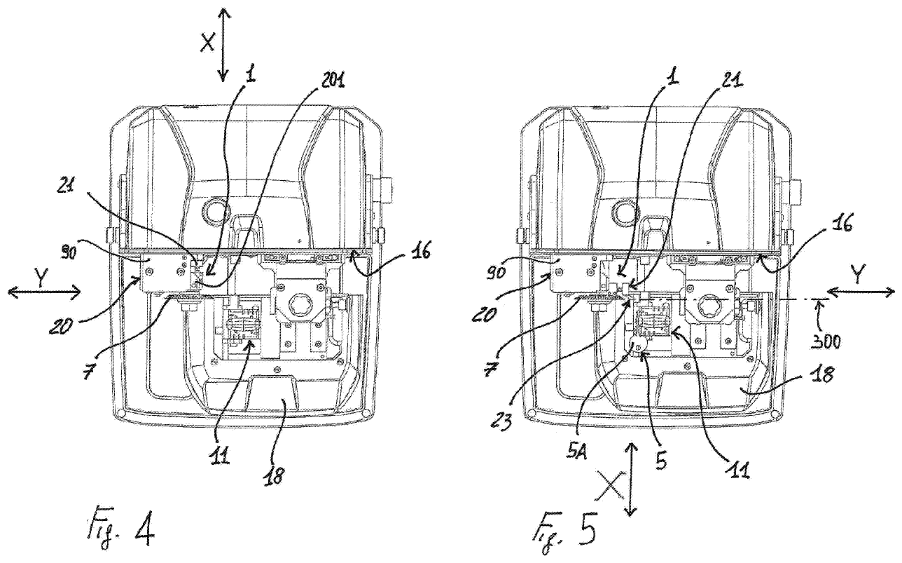

The machine 3 comprises at least one clamp 11 configured to block an original key 5 to be copied, i.e., for which the cuts are meant to be read. The clamp 11 defines a resting plane 200 for the key 5 and preferably an alignment direction 101 for the barrel portion of the key 5D. Such an alignment direction 101 is parallel to said resting plane 200 (see FIG. 6). In particular, the key 5 is arranged with one of the two faces 5A, 5B on the resting plane 200 and the alignment direction 101 is parallel to that along which the barrel portion 5D primarily extends.

The machine 3 according to the invention comprises a reading assembly 1 for reading the cuts of said key 5 and a prismatic cutting tool 7 having a shape per se known. Without going into particular detail, according to a known solution, the cutter 7 has a cutting edge 7B of a circular shape with a predetermined radius R1. Such a cutting edge 7B has a tapered/pointed shape, where such a shape is considered on a substantially radial section plane containing the rotation axis 103 of the cutting tool 7.

According to another aspect, the reading assembly 1 comprises a support 20 bearing a feeler element 21 (movable with respect to the support 20) to read the cuts of the original key. Such a feeler element 21 takes at least one reading position in which it is oriented towards the barrel portion 5D defining the cuts of the key 5. In such a condition, the feeler element 21 is movable with respect to the support 20, along a first reference direction Y (or axis Y), preferably orthogonal to the alignment direction 101 of the key 5 and preferably parallel to the resting plane 200 of the key 5.

The feeler element 21 comprises a reading end 23 configured to contact the key 5 at the cuts. Preferably, the reading end 23 is tapered along the direction Y, in the direction of the cuts 6 of the key 5. The reading end 23 identifies a reading edge 23A in a cutting blade shape, which profile extends transversely with respect to the resting plane 200 of the key 5 and which is oriented towards the cuts 6 of the key 5 once this is blocked in the clamp 11. The expression “blade shape” means a shape such that the profile of said reading edge 23A is tapered/pointed in the direction of the cuts 6 of the key 5. Instead, the term “transversely” means a condition whereby the edge 23A extends on a plane which transversely (preferably orthogonally) affects the resting plane 200.

In particular, the extension of the edge profile 23A is greater than the thickness of the cuts, a thickness considered as the distance between the two faces 5A, 5B of the key 5.

In accordance with the invention, between the support 20 and the feeler element 21 elastic means 25 are interposed, which push the feeler element 21 away from the support 20 along the axis Y. Such elastic means 25 preferably comprise a plurality of helicoidal springs having a first end acting on a surface of the support 20 and a second end acting on the feeler element 21.

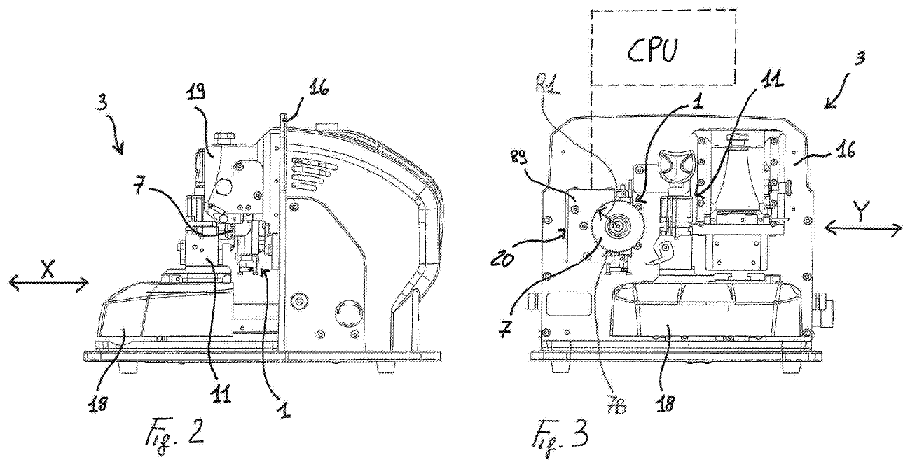

According to the present invention, the reading assembly 1 further comprises a position sensor 8 configured to continuously detect the position, or the change of position, of the feeler element 21 with respect to the support 20. The position sensor 8 is electrically connected to a control unit CPU of the machine 3, outlined with a dashed line in FIG. 3.

According to the present invention, one of said clamp 11 and said support 20, preferably said clamp 11, is movable along at least a second reference direction X (or axis X) orthogonal to the first reference direction Y. Preferably, such a second direction X is parallel to the resting plane 200 of the key 5 and parallel to the alignment direction 101 of the barrel portion 5D indicated above. The displacement along the second direction X of the clamp 11, or, alternatively, of the support 20, is controlled by said control unit (hereinafter CPU). As better highlighted below, during the movement of the component (clamp 11 or support 20) along the axis X, the elastic means 25 push the reading end 23 in contact with the cuts 6 of the key 5 so that the same is affected by the shape of the cuts themselves. Upon the continuous contact with the cuts of the key 5, the reading end 23 undergoes displacements along the axis Y, where such displacements are determined precisely by the shape of the cuts. Furthermore, during the movement of the component (clamp 11 or support 20) along the axis X, the position sensor 8 continuously detects the displacements of the reading end 23 along the axis Y. The expression “continuously” means an operating mode by which the position sensor 8 is active during the entire reading step in which the reading end 23 is in contact with the cuts 6 of the key 5. Therefore, the sensor 8 detects any possible displacement along the axis Y for each point of the cuts 6.

The operating principle of the duplicating machine 3 according to the invention is described below in detail, with particular reference to the function of the reading assembly 1, in the hypothesis that during the reading of the cuts, the clamp 11 is movable along said second reference direction X, while the support 20 maintains a fixed position. The key 5 to be copied is fastened on the clamp 11. In the reading position, the elastic means 25 of the assembly 1 exert a constant thrust on the feeler 21 along the axis Y so that the edge profile 23A of the reading end 23 is in contact with the barrel portion 5D defining the cuts of the key 5. The CPU moves the clamp 11 along the axis X. During such a movement of the clamp 11, the position of the feeler element 21 remains fixed along the axis X itself. Due to the movement of the clamp 11, the key 5 to be copied moves with respect to the feeler element 21. At the same time, due to the elastic means 25, the edge profile 23A of the reading end 23 remains constantly in contact with the cuts of the key 5 during the movement along X of the key 5. Due to the very slim shape thereof, such an edge profile 23A runs along the cuts, and the feeler element 21 moves along the axis Y in a manner corresponding to the cuts of the key 5 itself. The displacements along the axis Y are continuously detected by the position sensor 8 and subsequently sent to the CPU. The latter reconstructs and stores the cuts of the original key 5. At the end of the reading step, the original key 5 is removed from the clamp 11.

At a subsequent step, the cuts of the original key 5 are replicated on a blank key. Preferably, the blank key is blocked in the same clamp 11 previously used for blocking the original key. Alternatively, the blank key may also be blocked on a clamp different from that employed for reading the original key. In any case, when the blank key is blocked, the machining thereof may be activated. The CPU moves the clamp blocking the blank key along the axes X and Y defined above and in accordance with the cuts of the original key. More precisely, the CPU moves the blocking clamp, with respect to the cutting tool 7 which is simultaneously actuated. The movement in X and Y of the blocking clamp and the simultaneous action of the cutting tool 7 leads to the reproduction of the cuts on the barrel portion of the blank key on which the cutting tool 7 acts. The rotation axis of the cutting tool 7 is substantially parallel to the axis X.

In accordance with what has just been indicated above, during the reading step, the thrust provided by the elastic means 25 on the feeler 21 advantageously allows the edge profile 23A of the reading end 23 to remain constantly in contact with the surface of the key 5 defining the cuts. Due to the relative movement of the key 5 with respect to the feeler 21, the edge profile 23A runs on the surface of the cuts so that the reading end 23 follows the profile of the surface itself, undergoing corresponding displacements along the first direction Y.

With reference to the reading end 23, according to another aspect, the profile of the reading edge 23A is substantially corresponding, in terms of radius of curvature and shape, to the profile of the cutting tool 7. In other words, the profile of the reading edge 23A has a curvilinear pattern with a radius of curvature R2 substantially corresponding to the radius R1 of the cutting tool 7. Furthermore, the profile of the edge 23A (considered on a radial plane passing through the center of curvature of the profile itself) has a tapered/pointed shape corresponding to that provided for in the cutting edge 7B of the cutting tool 7.

The shape correspondence between the profile of the reading edge 23A and the cutting edge 7B makes the key duplication particularly accurate and allows to make a precise copy of the key. In fact, the reading of the cuts 6 occurs by means of an instrument (reading edge 23A) which has the same geometrical features as the one subsequently used for cutting (cutting edge 7B). Therefore, also the processing of the signals (sent by the position sensor 8) by the CPU is advantageously limited. Furthermore, said shape correspondence facilitates and makes more accurate the reading of the cuts 6 of the key 5 without requiring any compensation movement and/or any feedback system to move the reading end 23 according to the direction of the thickness of the key.

Advantageously, the edge 23A also exerts a scraping action on the surface defining the cuts. Therefore, any dirt or possible debris are eliminated and will not affect the reading of the cuts in any way. This advantageous aspect adds to the one determined by the employment of a position sensor which does not directly read the key cuts, but rather detects the displacement of the feeler element 21 with respect to the support 20. Therefore, the reading of the position sensor is not affected by the surface conditions of the cuts. In this regard, also the shape of the reading end 23 advantageously contributes in terms of reading accuracy.

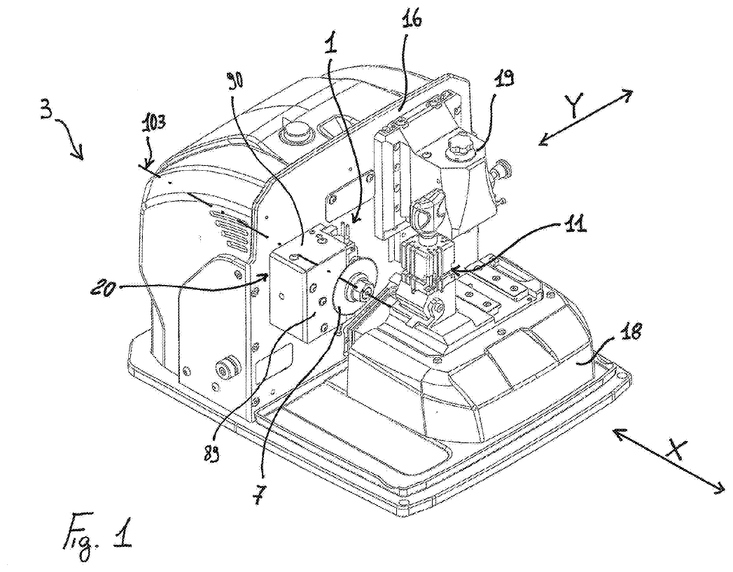

According to a preferred, but not exclusive, embodiment, shown in FIGS. 1 to 5, the machine 3 comprises a wall 16 on which the support 20 is stably installed. The cutting tool 7 emerges with respect to this wall 16 so that the rotation axis 103 thereof is substantially parallel to the axis X. The clamp 11 is preferably installed on a base 18 which is movable, in a manner controlled by the CPU, along the axis X and along the axis Y.

FIGS. 6 to 17 refer, in particular, to the assembly 1 for reading the cuts of the key. Such an assembly 1 comprises guiding means to guide the feeler element 21 along the axis Y. In accordance with a preferred embodiment of the invention, the guiding means comprise at least one guide pin 51 integral with a component selected from the support 20 and the feeler element 21. The guiding means further comprise at least one longitudinal cavity 52 defined in the other component selected from the support 20 and the feeler element 21. Said at least one guide pin 51 is slidingly inserted into said at least one longitudinal cavity 52.

With reference to the solution in the Figures, the feeler element 21 comprises a body 210, of a substantially prismatic shape, bearing the reading end 23, configured, in fact, to contact the original key 5 at the cuts. Preferably, the reading end 23 and the edge profile 23A are made in a one piece with the body 210. The reading end 23 and the edge profile 23A are placed in a preferably central position of the body 210, a position considered along a development direction substantially orthogonal to the resting plane 200.

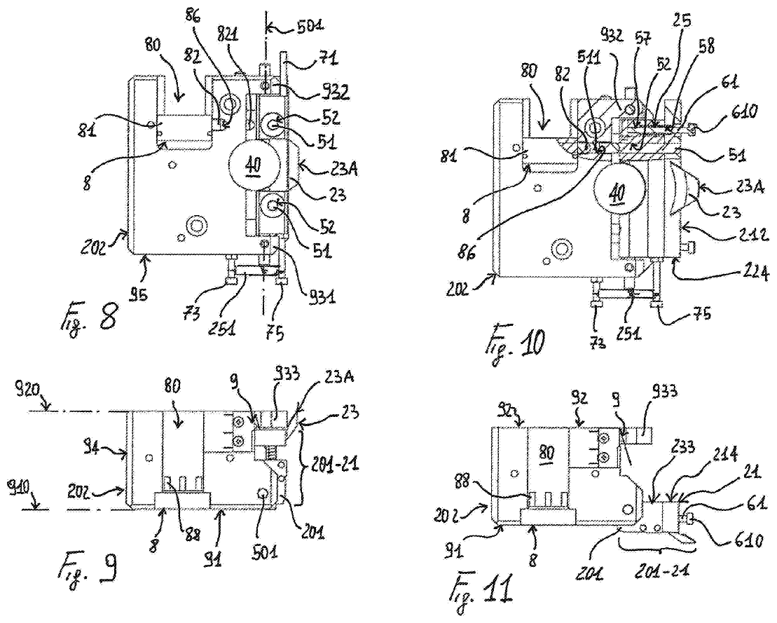

Preferably, the support 20 of the assembly 1 comprises a first body 201 defining a first surface 221 facing a first surface 211 of the body 210 of the feeler element 21 (see FIGS. 12 and 13). The first body 201 defines a pair of longitudinal cavities 52 passing between the first surface 221 and a second surface 222 opposite to the first surface 221. A longitudinal guide pin 51, integral with the body 210 of the feeler element 21, is slidingly inserted in each of the cavities 52. In particular, each guide pin 51 emerges from the first surface 211 of the body 210 of the feeler element 21. In the embodiment shown in the Figures, the guiding means therefore comprise a pair of guide pins 51 and a corresponding pair of longitudinal cavities 52 which configure a guiding direction of the feeler element 21.

Preferably, the position sensor 8 is integral with the support 20 and operatively arranged so as to detect the position, or the change of position, of a guide pin 51 inside the longitudinal cavity 52 in which it is slidingly inserted. In other words, according to this solution, the displacement of the feeler element 21 derives from the displacement of one of the pins 51 integral with the feeler element 21 itself. The position sensor 8 may be a potentiometer sensor. Alternatively, the position sensor 8 may also be of the optical type. It is furthermore pointed out that, according to the invention, the sensor 8 detects the displacement of the feeler element 21 which is not affected by the cleanness conditions of the surface of the key defining the cuts. The position sensor 8 is preferably of the analog type, precisely to continuously detect the change of position along the axis Y of the reading end 23 in response to the shape of the key 5 during the relative movement of the latter along the axis X with respect to the reading end itself.

According to another aspect, the reading assembly 1 comprises end-of-stroke means, which establish a maximum travel for displacing the feeler element 21 with respect to the support 20. In other words, the end-of-stroke means constrain the movement of the feeler element 21 along the guiding direction configured by the guiding means (51, 52 in the example shown in the Figures).

A possible, but not exclusive, embodiment of the end-of-stroke means (shown in the Figures) is described below. A first body 201 of the support 20 defines at least two first cavities 57, preferably blind. The body 210 of the feeler element 21 defines two second through cavities 58, each of which is axially aligned to one of said first cavities 57. Each of the first cavities 57 comprises at least one threaded segment. The end-of-stroke means also comprise a plurality of large head screws 61, each of which passes through one of said second cavities 58 and is screwed on the threaded segment of the corresponding first cavity 57. For each of the screws 61, the large head 610 remains in a position facing a second surface 212 of the body 210 opposite to the first surface 211 facing the support 20. Thereby, the feeler element 21 still occupies a position which is between the position of the first body 201 of the support 20 and the position occupied by the large head 610 of the screws 61. Overall, the position of said large heads 610 establishes the end-of-stroke position for the movement of the feeler element 21.

According to another preferred, but not exclusive, technical solution, the first cavities 57 defined in the first body 201 of the support 20 comprise a first outermost segment and a second innermost segment. The first outermost segment has a greater diameter than the innermost segment. The latter is threaded due for screwing one of the screws 61 of the end-of-stroke means.

The elastic means 25 comprise a plurality of springs each of which is inserted into the outermost segment of one of said first cavities 57. For each spring, a first end thereof acts against a surface of the first body 201 of the support 20, while a second end, opposite to the first one, emerges outwardly from said first body 201 and acts against a surface of the feeler element 21, in particular against the surface 211 defined above. During the reading of the cuts, the first body 201 of the support 20 maintains a constant position along the axis Y. As a result, the displacement along the axis Y itself of the feeler element 21 (movement imposed by the cuts of the key 5) occurs in opposition to the elastic force generated by the springs.

According to an alternative embodiment, not shown in the Figures, the springs may be placed in cavities defined in the first body 201 of the support 20, distinct from the cavities in which the screws 61 of the end-of-stroke means are screwed. According to a further variant, the springs may be accommodated in cavities defined in the feeler element 21 so that an end thereof emerges outwardly, in abutment against a surface of the support 20, in particular against the surface 221 of the first body 201. In the solution shown in the Figures, two first dead cavities 57 and two second through cavities 58 are provided for. The two first cavities 57, as well as the two second cavities 58, are defined in a position opposite with respect to the reading end 23 of the feeler element 21. This solution allows a greater stability and a more uniform movement of the feeler element 21.

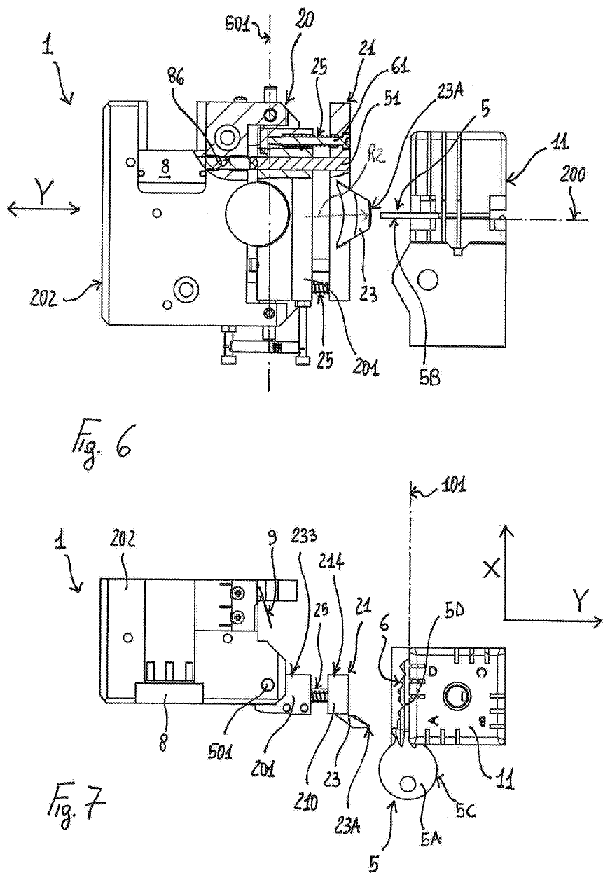

According to another aspect visible in the Figures, the support 20 comprises a first body 201 and a second body 202 bearing the first body 201 and the feeler element 21 operatively connected thereto. For description purposes only, the set formed by the first body 201 and by the feeler element 21 will also be indicated by the expression “operating unit 201-21” (shown in FIGS. 9 and 11).

Preferably, the operating unit 201-21 is rotatable with respect to said second body 202 about a rotation axis 501 which is preferably orthogonal to the axis Y and also to the axis X. More precisely, the first body 201 is hinged to the second body 202. Therefore, the first body 201, rotating about the axis 501, puts in rotation also the feeler element 21. In particular, in accordance with this solution, the operating unit 201-21 may rotate from a first position and a second predetermined position. In the first position, also referred to as the reading position, the displacement direction of the feeler element 21, configured by the guiding means 51, 52, coincides with the axis Y defined above, for the purpose of reading the cuts of the key 5. Instead, in the second predetermined position, or resting position, the displacement direction configured by the guiding means 51, 52 is preferably parallel to the axis X defined above. In any case, in the second predetermined position, the displacement direction of the feeler element 21 is not parallel to the axis Y.

The rotation of the operating unit 201-21 between the two predetermined positions is particularly advantageous when the support 20 is installed at the cutting tool 7, as in the machine 3 shown in FIGS. 1 to 5. In this regard, FIG. 4 shows the machine 3 in a substantially cutting configuration taken for machining the blank key. In this configuration, the operating unit 201-21 occupies the resting position in order not to impede the cutting of the key by the cutting tool 7. On the contrary, FIG. 5 shows the machine in a copying configuration, so that the unit 201-21 occupies the reading position. In this configuration it is observed that the reading end 23A is arranged adjacent to the cutting tool 7 substantially on a same reference plane 300 orthogonal to the resting plane 200 of the key 5 and parallel to the axis Y. In essence, in the copying configuration, the reading end 23 operatively substitutes the cutting tool 7. In the embodiment, the rotation axis 501 is, therefore, parallel to the axis Z. However, in an alternative embodiment (not shown, but still falling within the scope of the present invention), the operating unit 201-21 may rotate about an axis parallel to the axis Y, in any case between at least two predetermined positions for each of which the displacement direction of the feeler element 21 is parallel to the axis Y. In this hypothesis, a first of such positions corresponds to a reading position, while the other to a resting position which, therefore, does not allow the reading.

FIGS. 6 and 7 show the assembly 1 in a first configuration in which the operating unit 201-21 occupies the reading position; FIGS. 8 and 9 show, instead, the support 20 in a second configuration in which the operating unit 201-21 occupies the resting position. Preferably, to manually rotate the operating unit 201-21 between the two predetermined positions, gripping means, accessible for an operator, integral with the second portion 201 itself or alternatively with the feeler element 21, are provided for. Preferably, such gripping means are defined by one or more rods 71 emerging from a third surface 223 of the first body 201 which is substantially orthogonal to the first surface 221 and to the second surface 222 defined above.

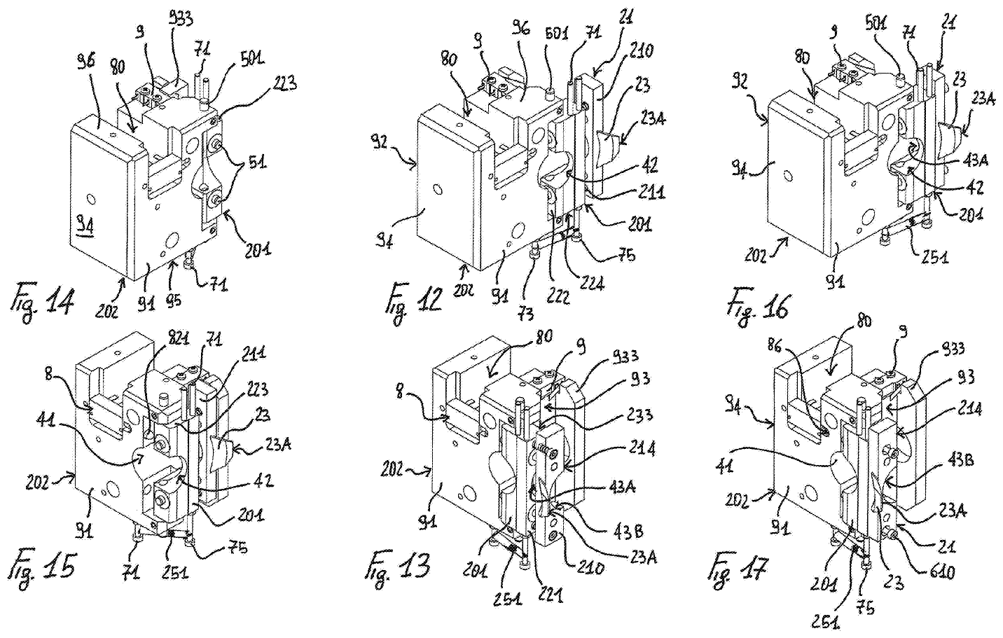

FIGS. 12 and 13 show perspective views, from different points of view, of the support 20 in said first configuration defined above. FIGS. 14 and 15 show perspective views, also from different points of view, of the support 20 in the second configuration defined above. In particular, a preferred embodiment of the two bodies 201, 202 constituting the support 20 may be appreciated from these Figures.

As shown, for the second body 202, a front face 91, a rear face 92 counterposed to said front face 91, a first side face 93 and a second side face 94 opposite to each other are identified. For the second body 202, a lower face 95 and an upper face 96 are also identified. The terms “front”, “rear”, “lower” and “upper” identify the relative faces of the second body 202 with respect to the possible installation mode of the support 20 in the machine 3 for duplicating keys in FIGS. 1 to 5.

The first body 201 of the support 20 is connected to the second body 202 at the first side face 93. In particular, such a first side face 93 has a substantially C-shape defined by two counterposed sides 931, 932 facing each other (see FIGS. 8 and 10) at which the first body 201 is hinged. At the first side face 93 a shoulder 933 also emerges which extends parallel to the reference plane 920 defined by the rear face 92. Overall, the C-shape of the first side face 93 and the shoulder 933 form a space in which the first body 201 and the feeler element 21 are placed when they occupy the resting position defined above. This condition is clearly visible in FIGS. 8 and 9. In particular, from the plan view of FIG. 9 it is observed that in the resting position, the first body 201 and the feeler element 21 remain between two reference planes 910, 920 on which the front face 91 and the rear face 92 of the second body 202 extend. In this condition, the reading end 23 of the feeler element 21 is placed in a position adjacent to the shoulder 93 defined above.

Furthermore, the support 20 preferably comprises further elastic safety means interposed between the first body 201 and the second body 202 so as to maintain the operating unit 201-21 in the corresponding (reading or resting) position reached upon the rotation about the rotation axis 501. In accordance with a possible embodiment shown in the Figures, the elastic safety means comprise at least one spring 251 having a first end connected to a first pin 73 emerging from the lower face 95 of the second body 202 and a second end connected to a second pin 75 emerging from a surface 224 of the first body 201. In essence, such a surface 224 defines a lower face of the first body 201 and is substantially opposite to the third surface 223 from which the two rods 71 usable for rotating the operating unit 201-21 emerge. The lower face 95 from which the first pin 73 emerges, is, therefore, in a position close to the surface 224 from which said second pin 75 emerges. The first pin 73 maintains a fixed position, while the second pin 75 rotates integral with the operating unit 201-21, varying the direction of the elastic force with respect to the rotation axis 501. In particular, when the operating unit 201-21 reaches one of the two predetermined (resting or reading) positions, the second pin 75 occupies a position so that the elastic force tends to maintain the operating unit 201-21 itself in the position reached.

Preferably, the assembly 1 comprises a second sensor 9 installed on the second body 202 to detect the correct reaching of the resting position by said operating unit 201-21. Such a second sensor 9 may also be connected to a control unit to send a signal corresponding to the operating condition taken by the operating unit 201-21. According to another aspect, the second body 202 defines a seat 80 for positioning the position sensor 8. Preferably, such a seat 80 extends between the front face 91 and the rear face 92. The second body 202 further defines a through hole 86 between the seat 80 and the first side face 93 at which the rotation axis 501 of the operating unit 201-21 is defined. The through hole 86 is defined so as to be aligned with a longitudinal cavity 52 passing through the first body 201, in which cavity a guide pin 51 is slidingly inserted, in accordance with a solution already described above. In particular, such an alignment condition is reached when the operating unit 201-21 takes the reading position (see, for example, FIGS. 6 and 10). The through hole 86, therefore, has the function of allowing the sensor 8 to detect the position, or the change of position, of the guide pin 51 (integral with the feeler element 21) inside the corresponding longitudinal cavity 52.

Preferably, the position sensor 8 is of the linear potentiometer type and comprises a sensor body 81, accommodated inside the seat 80, and a movable rod 82 slidingly inserted into the through hole 86. When the operating unit 201-21 takes the reading position (FIGS. 6 and 10), the end 821 of the movable rod 82 is in contact with an end 511 of a guide pin 51. Thereby, each displacement of the guide pin 51, i.e., of the feeler element 21, with respect to the first body 201, determines a corresponding displacement of the movable rod 82. Each displacement of the movable rod 82 produces in turn a corresponding electrical signal in the sensor body 81. The sensor body 81 comprises electrical connections 88 adapted to allow the electrical connection with the CPU. Such electrical connections 88 are advantageously placed inside the seat 80 and, therefore, in a position inside the second body 202. In this regard, in FIGS. 1 to 5, the front face 91 and the upper face 96 are coated with protection elements 89, 90 to prevent dirt entering into the seat 80 and/or into the channel 86 referred to above.

As an alternative to the potentiometer sensor, an optical sensor (not shown) accommodated inside the seat 80 may be employed. In this case, the through hole 86 may be used for the transmission of the light beam intended to intercept the end 511 of the guide pin 51. The change of position of the pin 51 determines a change in the conditions of the light beam and therefore the generation, by the optical sensor, of a corresponding electrical signal sent to the CPU. The optical sensor continuously detects the change in the condition of the light beam, i.e., it provides a continuous signal characteristic of the change of position along Y of the reading end 23.

FIGS. 8 and 15 allow to observe the position taken by the end 821 of the rod 82 when the operating unit 201-21 occupies the resting position. In such a position, the longitudinal axis of the guide pin 52 is rotated by 90° with respect to the longitudinal axis of the rod 82 of the sensor 8. Therefore, the end 821 of the rod 82 is substantially free and faces the innermost surface 233 of the first body 201. Such an innermost surface 233, instead, faces the shoulder 933 of the second body 202 when the operating unit 201-21 occupies the reading position (see FIGS. 7 and 11). An innermost surface 214 of the feeler element 21 also faces the shoulder 933 when the operating unit 201-21 occupies said reading position.

According to a preferred embodiment shown in the Figures, the two portions 201, 202 of the support 20 are configured to define a passageway 40 for the rotation shaft (parallel to the axis X) of the cutting tool 7. Thereby, the support 20 may advantageously be installed at the cutting tool 7. This solution, clearly visible in FIGS. 1 to 5, allows to make the duplicating machine more compact and leaves, for example, the possibility of installing another assembly 19 for laser key or other types of machining.

The passageway 40 extends between the front face 91 and the rear face 92 of the second body 202, also partially passing through the shoulder 933. Preferably, such a passageway is partially defined between the two bodies 201, 202 of the support 20 and more precisely between the first side face 93 of the second body 202 and the face 222 of the first body 201 facing thereto. These two faces 93, 222 each define a corresponding concave recess 41, 42. When the operating unit 201-21 occupies the reading position (see FIGS. 6 and 10) the two recesses 41, 42 face each other and define a segment of the passageway 40. Also, the innermost surface 233 of the first body 201 and the innermost surface 214 of the feeler element 21 are shaped so as to define further recesses 43.43B (shown in FIG. 8). When the operating unit 201-21 occupies the resting position (condition in FIGS. 3 and 10) said further recesses 43A, 43B occupy a position facing the recess 41 defined at the side face 93 of the second body 202 so as to reconfigure anyway the passageway 40 for the rotation shaft of the cutter 7.

FIGS. 10, 11, 16 and 17 show the operating unit 201-21 in the reading position and, at the same time, in a particular condition whereby the feeler element 21 is in contact with the first body 201 of the support 20. This condition, said zero travel, it is substantially opposite to that shown in FIGS. 6 and 7 described above, in which the feeler element 21 is shown in the condition of maximum travel established by the end-of-stroke means. From the comparison between FIGS. 6 and 10, partially sectional, it is possible to observe the different position taken in the two cases (zero and maximum travel) by the end 821 of the rod 82 of the sensor 8. In particular, in the condition of FIG. 5 it is observed how the pin 51, on the end 511 of which the rod 82 of the sensor 8 acts, is partially inside the passageway defined in the second body 202 of the support 20. In FIGS. 11 and 17 it is further observed that in the zero-travel condition, for each of the screws 61 (constituting the end-of-stroke means), the corresponding large head 610 takes a distal position from the feeler element 21. During the reading of the cuts of the key 5, the travel of the feeler element 21 will therefore be variable between a zero value and the maximum travel value established precisely by the position of the large head 610 of the screws 61. The machine in accordance with the invention allows to fulfill the aims and objects set. In particular, the reading assembly of the duplicating machine in accordance with the invention allows to accurately copy the cuts of a key without being affected by the conditions of the cuts surface. Furthermore, the reading assembly is cheaper and more reliable than those usually employed in duplicating machines of the known type.

1. A machine for duplicating keys, comprising:
a clamp configured to block at least one flat key to be copied, wherein said clamp defines a resting plane for said key;
a reading assembly for reading the cuts of said key;
a cutting tool for reproducing said cuts on a blank key, wherein the reading assembly comprises:
a support bearing a feeler element, wherein said feeler element is movable, with respect to said support, along a first reference direction (Y) parallel to said resting plane, said feeler element comprising a reading end contacting said original key at said cuts;
elastic means interposed between said support and said feeler element, wherein said elastic means push said feeler element away from said support so that said reading end is in contact with said cuts;
a position sensor configured to detect the position, or the change of position along said first reference direction (Y), of said feeler element with respect to said support, said position sensor being electrically connected to a control unit of said machine,
wherein a component, selected from said support and said clamp is movable along at least a second reference direction (X) orthogonal to said first reference direction (Y) and parallel to said resting plane and wherein, during the movement of said component along said second reference direction (X), said reading end is constantly in contact with said cuts, so as to follow the shape thereof, and said position sensor continuously detects said change of position along said first reference direction (Y), said change of position being determined by said shape of said cuts.

2. The machine according to claim 1, wherein said reading end comprises a reading edge with a profile corresponding, in terms of curvature and shape, to that of said cutting tool.

3. The machine according to claim 1, wherein said assembly comprises at least one guide pin integral with a component selected from said support and said feeler element, and a longitudinal cavity defined in the other component selected from said support and said feeler element, wherein said at least one guide pin is slidingly inserted into said at least one longitudinal cavity.

4. The machine according to claim 1, wherein said assembly comprises a pair of longitudinal cavities defined in a body of said support, and a pair of pins integral with said feeler element each of which is slidingly inserted into one of said longitudinal cavities, wherein said pins are arranged on opposite sides with respect to said reading end of said feeler element.

5. The machine according to claim 3, wherein said position sensor is integral with the support and detects the position, or the change of position along said first direction (Y), of a guide pin inside a longitudinal cavity in which it is slidingly inserted.

6. The machine according to claim 1, wherein said assembly comprises end-of-stroke means which establish a maximum travel for displacing said feeler element with respect to said support.

7. The machine according to claim 6, wherein said end-of-stroke means comprises:
a plurality of first cavities defined in a body of said support, each of said first cavities comprising at least one threaded segment;
a plurality of second cavities passing through the body of said feeler element, wherein each of said second cavities is axially aligned with a corresponding one of said first cavities;
a plurality of large head screws, wherein each screw passes through one of said second through cavities and is screwed into said threaded segment of a corresponding one of said first cavities, said feeler element occupying a position between the position of said support and the position taken by the large head of said screws.

8. The machine according to claim 7, wherein said first cavities comprise a first outermost segment and a second innermost segment, said outermost segment having a greater diameter than said innermost segment, said innermost segment being threaded for screwing one of the screws of said end-of-stroke means, and wherein said elastic means comprise a plurality of springs each of which is inserted into the outermost segment of one of said first cavities, each spring comprising a first end acting against a surface of said support and a second end, opposite to said first end, acting against a surface of said feeler element.

9. The machine according to claim 1, wherein said support comprises a first body and a second body hearing an operating unit consisting of said first body and said feeler element, wherein said operating unit is rotatable with respect to said second body about a rotation axis between a first position and a second predetermined position, wherein the displacement direction of said feeler element, with respect to said support is parallel to said first reference direction (Y) when said operating unit occupies said first predetermined position and is not parallel to said first reference direction (Y) when said operating unit occupies said second predetermined position.

10. The machine according to claim 9, wherein when said unit occupies said second predetermined position, said displacement direction of said feeler element is parallel to said second reference direction (X).

11. The machine according to claim 9, wherein said rotation axis (501) is orthogonal to said first reference direction (Y) and to said second reference direction (X).

12. The machine according to claim 9, wherein said assembly comprises gripping means, accessible for an operator, to rotate said operating unit between said predetermined positions, said gripping means being integral with said first body of said support and/or with said feeler element.

13. The machine according to claim 9, wherein said assembly comprises elastic safety means interposed between said first body and said second body so as to maintain said operating unit in the corresponding predetermined position reached upon the rotation about said rotation axis.

14. The machine according to claim 13, wherein said elastic safety means comprise at least one spring having a first end connected to a first pin integral with said second body at a lower face thereof, said spring comprising a second end connected to a second pin integral with said first body at a lower face thereof close to the surface of said second body from which said first pin emerges, wherein said first pin maintains a fixed position, and wherein when said operating unit reaches one of the two predetermined positions, said second pin occupies a position so that the elastic force exerted by said spring tends to maintain the operating unit itself in the position reached.

15. The machine according to claim 9, wherein said assembly comprises a further sensor installed on said second body to detect the correct reaching of said second predetermined position by said operating unit.

16. The machine according to claim 9, wherein said second body defines a seat for positioning said position sensor.

17. The machine according to claim 16, wherein said second body defines a through hole between said seat and a side face of said second body at which said rotation axis of said operating unit is defined, said through hole being defined so as to be, when the operating unit takes said first predetermined position, axially aligned with a longitudinal cavity defined through said first body and in which a guide pin integral with said feeler element is slidingly inserted, said sensor detecting the position, or the change of position, of said guide pin sliding in said longitudinal cavity.

18. The machine according to claim 17, wherein said position sensor is of the linear potentiometer type and comprises a sensor body accommodated inside said seat, and a movable rod slidingly inserted into the through hole, said rod comprising an end which contacts an end of said guide pin when said operating unit occupies said first predetermined position.

19. The machine according to claim 17, wherein said position sensor is of the optical type and comprises a body accommodated in said seat, said optical sensor generating a light beam passing through said through hole and intercepting an end of said guide pin when said operating unit occupies said first predetermined position.

20. The machine according to claim 9, wherein the two bodies of said support are configured to define a passageway for the rotation shaft of a cutting tool of a key duplicating machine, said passageway being defined between a side surface of the second body and a side surface of the first body facing each other and defined at said rotation axis, wherein each of said side surfaces defines a corresponding concave recess so that, when said operating unit occupies said first predetermined position, the two recesses face each other and define a segment of said passageway, said first body and said feeler element each comprising an innermost surface facing said side surface of said second body when said operating unit occupies said second predetermined position, and wherein each innermost surface defines a further recess facing said recess defined by said side surface of said second body when said operating unit occupies said second predetermined position.
